(19) United States
(12) Patent Application Publication
(10) Pub. No.: US 2004/0262992 A1
(43) Pub. Date: Dec. 30, 2004

(54) Method for improving the control behaviour of a motor vehicle comprising anti-lock braking control

(76) Inventors: Helmut Fennel, Bad Soden (DE); Iyica Batistic, Frankfurt/M (DE)

Correspondence Address: Joseph V Coppola, Rader Fishman & Grauer, Suite 140, 39533 Woodward Avenue, Bloomfield Hills, MI, 48304, US

(21) Appl. No.: 10/496,198

(22) PCT Filed: Nov. 20, 2002
(86) PCT No.: PCT/EP02/12999

(30) Foreign Application Priority Data
Nov. 26, 2001 (DE) 101 57 629.3
Oct. 9, 2002 (DE) 102 47 082.0

(51) Int. Cl. B60T 8/60

(52) U.S. Cl. 303/150; 303/149

(57) ABSTRACT

In a method of improving the control behavior of a motor vehicle with anti-lock control, in particular for improving the brake performance on a homogeneous ground, where forces or pressures that act on wheels and tires are determined by sensors and used as control quantities for a motor vehicle control system, both front wheels are adjusted to their brake force maximums, and the front wheel with the lower instantaneously measured brake force or brake pressure is adjusted by a specific brake pressure build-up to its brake force maximum, whereas the other front wheel and the rear wheels are operated by means of a significantly decelerated brake pressure build-up.

The present invention relates to a method of improving the control behavior of a motor vehicle with anti-lock control, in particular for improving the brake performance in braking maneuvers on a homogeneous ground, where forces or pressures that act on wheels and tires are determined by sensors and used as control quantities for a motor vehicle control system.

WO 00/51861 discloses a method of determining the maximum or minimum force. It is known in the art that the maximum brake performance is achieved by keeping the wheels in the range of the coefficient of friction μ that is maximal for the given roadway. The force or pressure maximum corresponds to the maximum coefficient of friction μ. This condition cannot be maintained in practical operations as the coefficient of friction μ can vary. A new instability indicates a change towards the lower coefficient of friction.

It is considered as a shortcoming in the prior art method that a change towards the higher coefficient of friction is not detected.

Therefore, an object of the invention is to provide a method detecting a change towards higher coefficients of friction.

According to the invention, this object is achieved in that in braking maneuvers on a homogeneous ground the brake pressures or brake forces of both front wheels are adjusted to their brake force maximums, and the front wheel with the lower instantaneously measured brake force or brake pressure is adjusted by a specific brake pressure build-up to its brake force maximum, while the other front wheel and the rear wheels are operated by means of a significantly decelerated brake pressure build-up.

To render the method of the invention more concrete, the maximum transmittable brake forces and the minimum transmittable brake forces or the maximum transmittable brake pressures and the minimum transmittable brake pressures are determined from force or pressure data of both front wheels.

A favorable improvement of the idea of the invention arranges for a brake pressure adaptation to be performed when the following conditions are satisfied in a comparator:

a) both front wheels are on the stable branch of the μ slip curve.

b) Fx_{FL}≧k_{Fx}·Fx_{FLmax} and Fx_{FR}≧k_{Fx}·FX_{FRmax}

c) Fx_{FLmax}≧K_{symm}·Fx_{FRmax} and Fx_{FRmax}≧k_{symm}·Fx_{FLmax}

Fx_{FL}, Fx_{FR}: brake forces

k_{Fx}: force factor

Fx_{FRmax}, Fx_{FLmax}: brake force maximums

k_{symm}: symmetry factor

wherein a force factor k_{Fx} is preferably in the range of values 0.98<k_{Fx}<1, and a symmetry factor k_{symm} is preferably in the range of values 0.90<k_{symm}<1 and, in a particularly preferred manner, is in the range of values 0.95<k_{symm}<1.

In another favorable variant of the method of the invention, the decelerated brake pressure build-up takes place either in a pulsed fashion with long pauses, preferably pauses longer than 200 ms, or continuously with a low gradient, preferably with gradients lower than 50 bar/s.

Advantageously, the brake pressure adaptation is maintained until one of the conditions

d) Fx_{FLmax}<k_{symm}·Fx_{FRmax} or Fx_{FRmax}<k_{symm}·Fx_{FLmax}

e) Fx_{FL}≧kr_{Fx}·Fx_{FR} or Fx_{FR}≧kr_{Fx}·Fx_{FL}

Fx_{FRmax}, Fx_{FLmax}: brake force maximums

k_{symm}: symmetry factor

Fx_{FL}, Fx_{FR}: brake forces

kr_{Fx}: tolerance factor

is satisfied, wherein the symmetry factor k_{symm} is preferably in the range of values 0.90<k_{symm}<1 and, in a particularly preferred manner, is in the range of values 0.95<k_{symm}<1, and a tolerance factor kr_{Fx} is preferably in the range of values 1<kr_{Fx}<1.1, and the brake pressure adaptation is discontinued when the condition d) is satisfied, and when e)

is satisfied the command of brake pressure adaptation is modified to such effect that the front wheel which so far has been operated with a significantly decelerated brake pressure build-up along with the rear wheels is now adjusted to its brake force maximum, whereas the other front wheel along with the rear wheels is now operated with the significantly decelerated brake pressure build-up.

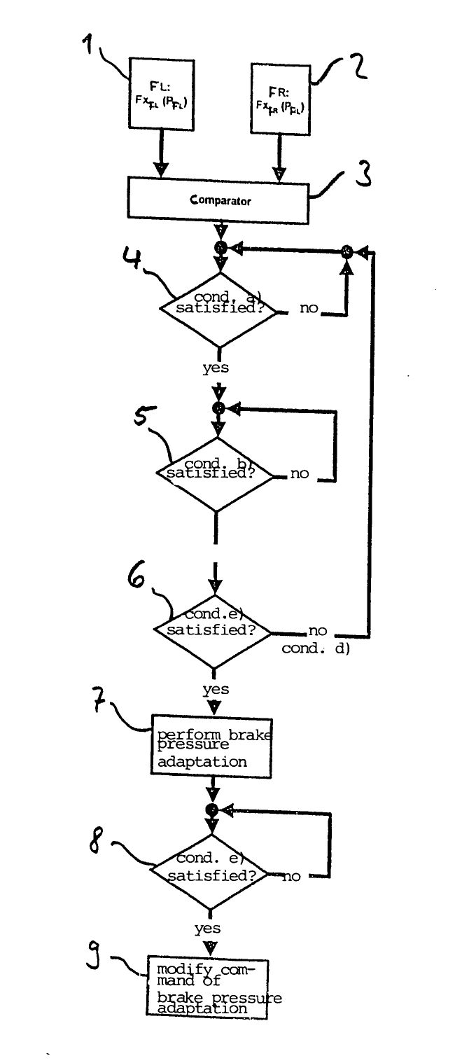

Further details, features and advantages of the method of the invention can be seen in the following description by way of FIG. 1.

FIG. 1 shows a diagram/flow chart of a brake pressure adaptation 7 during an ABS braking operation. The pressure or force data of the front left wheel (FL) 1 and the front right wheel (FR) 2 is sent to a comparator 3. In the following, only force data will be reviewed in the description of a favorable embodiment of the method of the invention because pressure data behaves in proportion to the force data.

The comparator 3 checks in a first step 4, whether the condition

b) both front wheels 1, 2 are in a stable phase

is satisfied, and the stable phase means that the front wheels 1, 2 are instantaneously on the stable branch of the μ slip curve. If this is not the case, the condition a) will be interrogated until it is satisfied. When the condition a) is satisfied, it is checked in a second step 5 whether the condition

b) Fx_{FL}≧k_{Fx}·Fx_{FLmax} and

Fx_{FR}≧k_{Fx}·Fx_{FRmax}

is satisfied, and the condition b) means that both front wheels 1, 2 are close to their brake force maximums (Fx_{FLmax}, Fx_{FRmax}), and a force factor kFx is preferably in the range of values 0.98<k_{Fx}<1. As long as the condition b) is not satisfied, the second step 5 is permanently executed. When the condition 2 is satisfied, it is checked in a third step 6 whether the condition

c) Fx_{FLmax}≧k_{symm}·Fx_{FRmax} and Fx_{FRmax}≧k_{symm}·Fx_{FLmax}

is satisfied. Condition c) means that both front wheels 1, 2 have symmetric brake force maximums (Fx_{FRmax}, Fx_{FLmax}), and the symmetry is described by a symmetry factor k_{symm}, which is preferably in the range of values 0.90<k_{symm}<1 and, in a particularly preferred manner, is in the range of values 0.95 <k_{symm}<1.

This condition safeguards that the ABS braking operation is carried out under homogeneous conditions. Another check of the transverse-dynamic conditions is unnecessary because with a relevant influence of transverse dynamics, a distinctly different force maximum of the front wheels 1, 2 would result due to the change in the μ slip curve. Thus, brake pressure adaptation 7 would be ineffective.

When the condition c) is not satisfied, what corresponds to the condition

d) Fx_{FLmax}<k_{symm}·Fx_{FRmax} or

Fx_{FRmax}<k_{symm}·Fx_{FLmax}

wherein d) implies that in the event of a major difference of the brake force maximums (Fx_{FLmax}, Fx_{FRmax}) of both front wheels 1, 2 in relation to each other, the brake pressure adaptation 7 is discontinued, with the symmetry factor k_{symm} being preferably in the range of values 0.90<k_{symm}<1 and, in a particularly preferred manner, being in the range of values 0.95<k_{symm}<1.

If, however, the conditions a) to c) apply, the said brake pressure adaptation 7 is introduced. As this occurs, the front wheel 1 or 2 with the lower instantaneously measured brake force (Fx_{FRmax} or Fx_{FLmax}) is adjusted to its brake force maximum (Fx_{FRmax} or Fx_{FLmax}) by a stepped or continuous brake pressure build-up, whereas a significantly decelerated brake pressure build-up takes place at the other front wheel 1 or 2 and at the rear wheels. The decelerated brake pressure build-up occurs either in a pulsed fashion with long pauses (pauses longer than 200 ms are especially preferred), or continuously with a low gradient (gradients lower than 50 bar/s are especially preferred).

Simultaneously, the search for either a new brake force maximum (Fx_{FRmax} or Fx_{FLmax}) or for confirmation of the old brake force maximum (Fx_{FRmax} or Fx_{FLmax}) is conducted by means of normal pulsed operation in the front wheel 1 or 2.

The brake pressure adaptation 7 is performed until the condition

e) Fx_{FL}≧kr_{Fx}·Fx_{FR} or

Fx_{FR}≧kr_{Fx}·Fx_{FL}

is satisfied in a fourth step 8, and e) implies that the currently measured brake forces (Fx_{FL}, Fx_{FR}) of the front wheels 1, 2 differ from each other by a tolerance factor kr_{Fx}, which is preferably in the range 1<kr_{Fx}<1.1. If this is the case, the command 9 of the brake pressure adaptation 7 is modified to such effect that the front wheel 1 or 2 which so far has been exposed to the significantly decelerated brake pressure build-up along with the rear wheels is now adjusted to its brake force maximum (Fx_{FLmax} or Fx_{FRmax}), whereas the other front wheel 1 or 2 along with the rear wheels is now exposed to the considerably slower brake pressure build-up. In this respect, the range 1<kr_{Fx}<1.1 is to be understood as a hysteresis to prevent having to switch permanently between two modes.

This method is used to adjust the front wheels to the two-sided brake force maximum (Fx_{FRmax} or Fx_{FLmax}) that safeguards an optimal brake performance under the given circumstances in terms of tires and roadway. Further, a minimum possible control frequency at a high brake force level in the majority of all wheels is achieved.

1-5. canceled

6. A method of improving the control behavior of a motor vehicle with anti-lock control, in particular for improving the brake performance on a homogeneous ground, where forces or pressures that act on wheels and tires are determined by sensors and used as control quantities for a motor vehicle control system,
wherein in braking maneuvers on a homogeneous ground the brake pressures or brake forces of both front wheels are adjusted to their brake force maximums, and the front wheel with the lower instantaneously measured brake force or brake pressure is adjusted by a specific brake pressure build-up to its brake force maximum, whereas the other front wheel and the rear wheels are operated by means of a significantly decelerated brake pressure build-up;

7. The method as claimed in claim 6,
wherein the maximum transmittable brake forces and the minimum transmittable brake forces or the maximum transmittable brake pressures and the minimum transmittable brake pressures are determined from force or pressure data of both front wheels.

8. The method as claimed in claim 7,
wherein a brake pressure adaptation is performed when the following conditions are satisfied in a comparator:
d) both front wheels are on the stable branch of the μ slip curve.
e) Fx_{FL}≧k_{Fx}·Fx_{FLmax} and Fx_{FR}≧k_{Fx}·Fx_{FRmax}
f) Fx_{FLmax}≧k_{symm}·Fx_{FRmax} and Fx_{FRmax}≧k_{symm}·Fx_{FLmax}
Fx_{FL}, Fx_{FR}: brake forces
k_{Fx}: force factor
Fx_{FRmax}, Fx_{FLmax}: brake force maximums
k_{symm}: symmetry factor
wherein a force factor k_{Fx} is preferably in the range of values 0.98<k_{Fx}<1, and a symmetry factor k_{symm} is preferably in the range of values 0.90<k_{symm}<1 and, in a particularly preferred manner, is in the range of values 0.95<k_{symm}<1.

9. The method as claimed in claim 6,
wherein the decelerated brake pressure build-up takes place either in a pulsed fashion with long pauses, preferably pauses longer than 200 ms, or continuously with a low gradient, preferably with gradients lower than 50 bar/s.

10. The method as claimed in claim 8, wherein the brake pressure adaptation is maintained until one of the conditions
d) Fx_{FLmax}<k_{symm}·Fx_{FRmax} or Fx_{FRmax}<k_{symm}·Fx_{FLmax}
e) Fx_{FL}≧kr_{Fx}·Fx_{FR} or Fx_{FR}≧kr_{Fx}·Fx_{FL}
Fx_{FRmax}, Fx_{FLmax}: brake force maximums
k_{symm}: symmetry factor
Fx_{FL}, Fx_{FR}: brake forces
kr_{Fx}: tolerance factor
is satisfied, wherein the symmetry factor k_{symm} is preferably in the range of values 0.90<k_{symm}<1 and, in a particularly preferred manner, is in the range of values 0.95<k_{symm}<1, and a tolerance factor kr_{Fx} is preferably in the range of values 1<kr_{Fx}<1.1, and the brake pressure adaptation is discontinued when the condition d) is satisfied, and when e) is satisfied the command of brake pressure adaptation is modified to such effect that the front wheel which so far has been operated with a significantly decelerated brake pressure build-up along with the rear wheels is now adjusted to its brake force maximum, whereas the other front wheel along with the rear wheels is now operated with the significantly decelerated brake pressure build-up.
